(19) United States
(12) Patent Application Publication
(10) Pub. No.: US 2018/0141716 A1
(43) Pub. Date: May 24, 2018

(54) System Including A Flask Or Shot Beer Glass

(71) Applicants: Ian Trenchfield, Parkland, FL (US); Shereen E. Young, Parkland, FL (US)

(72) Inventors: Ian Trenchfield, Parkland, FL (US); Shereen E. Young, Parkland, FL (US)

(21) Appl. No.: 15/357,353

(22) Filed: Nov. 21, 2016

(51) Int. Cl. B65D 25/20; A47G 19/22; F21V 33/00; F21V 23/04

(52) U.S. Cl. CPC B65D 25/20; A47G 19/2227; F21V 33/0036; F21Y 2115/10; A47G 2019/2238; A47G 2200/08; F21V 23/0471

(57) ABSTRACT

A system includes a plastic or glass of a substantially cylindrical container includes a first liquid. A flexible sleeve about a lower area about the container including a surface of a bottom upon the sleeve and an upper of the sleeve defines a substantially middle of a circular surface including a substantial segment of the sleeve. A flask generates an integration of a substantially cylindrical structure of a hollow curvature including a top and lower end. An inner side against a structure of a thin element about the sleeve urged against the system of a second liquid in with left to right contact to the thin element surface of the sleeve, and through the cylindrical structure of the thin element structure.

### FIELD OF THE INVENTION

A particular liquid such as a spirit, vodka or whisky provides a cylindrical container about a flask is providing in a bottom thereof, mounted inside serves as a shot glass using a beer or other liquids.

### BACKGROUND OF THE INVENTION

The invention relates to a shot glass of about 45 ml having a handle of a particular embodiment. The invention relates to a shot which includes a drinking vessel having a larger volume such as about 15 fluid ounces (500 ml) which is about ten times the size of a the shot. In other embodiments, this invention relates to a shot with a handle having a piece that is removable or connecting the handle of the shot to the rim of a larger drinking vessel. This invention also relates to a method of preparing and/or serving drinks in which a shot is attached to a wall of a larger glass.

Shot glasses are usually the size of miniaturized drinking glasses which are used to serve small volumes of liquid, typically between about said 45 ml termed shots. The use of the shot has conventionally involved either sipping of small quantity of liquor or mixed liquid in a single swallow.

A number of mixed alcoholic liquors are served with shot glasses. This also helps in drinking a lesser amount of liquor.

In “shooting” the contents of shot, methods or mixing the contents of shot, with those of larger volume drinking vessels have become widespread and popular. In such examples, a shot is filled with one type of alcohol, or mixture thereof, and a larger glass is filled (typically, in-part) with either an alcoholic or non-alcoholic drink. Thereafter, the shot is dropped in the larger glass and which the contents of the shot glass and the larger glass mixed when that glass is tilted for ingestion. Drink types which employ such mixing methods are known as Boilermakers, Bombers and Irish Bombs.

Although employing a conventional shot glass in preparing and serving such drink types is useful to achieve the general mixing effect, dropping a conventional shot into a larger glass (e.g., a Pilsner glass or beer mug) has several drawbacks. For example, a typical shot has smaller mass of the larger glassware's contents when dropped therein. Furthermore, after the shot has been dropped into the larger glass, when the drink is mixed, it is not uncommon for a shot to slide or move within the larger glass due to gravity. Because the shifting or movement of the shot is often sudden and/or unexpected, the shot may hit the mouth of the person drinking the beverage, potentially causing spillage or injury to the person's mouth and/or teeth.

The prior art, despite their widespread popularity fails with certain drink types, such as Jager Bombs, and cannot be sold to bar patrons in the same high volume manner by mobile tray shot servers as many other shot types. For example, certain popular shot types are carried around on trays by mobile servers that are amongst bar patrons that walk amongst bar crowds, hence shots provides by such mobile servers may be harmful and costly.

### SUMMARY OF THE INVENTION

A system includes a plastic or glass of a substantially cylindrical container includes a first liquid therein. A flexible sleeve about a lower area about the container including a surface of a bottom upon the sleeve and an upper of the sleeve defines a substantially middle of a circular surface including a substantial segment of the sleeve. A flask generates an integration of a substantially cylindrical structure of a hollow curvature including a top and lower end thereof. An inner side against the structure of a thin element about the sleeve urged against the system of a second liquid in with left to right contact to the thin element structure of the sleeve, and through the cylindrical structure of the thin element structure.

The invention relates to a shot having a bottom surface and a side wall extending upwardly from the bottom surface, in which the bottom surface and the side wall define a vessel for holding a liquid, the vessel having a closed first end and an open second end; and a handle associated with the side wall. The side wall may be continuous, and may be substantially circumferential in shape. The handle may be integral with the side wall, or attached to an outer surface of the side wall. This may be fixedly attached to an inner surface of the side wall or may be removably attached to an outer surface of the side wall, or may be removably attached to an inner surface of the side wall.

The shot may further have a sleeve which may be fixedly or removably attached to the handle. The side wall is capable of contacting the sleeve that suspends at the bottom surface and the side walls from the sleeve. The shot may further have a lighting mechanism which may be activated by motion. Further, each of the side wall, bottom surface and handle may independently be made of a polymer (which may be plastic), glass or metal.

A further invention relates to a shot having a bottom surface; a side wall extending upwardly from the bottom surface, wherein the bottom surface and the side wall define a vessel for holding a liquid and the vessel having a closed first end and an open second end; a handle; and sleeve attached to the handle, in which the side wall is capable of contacting the sleeve to suspend the bottom surface and the side walls from the sleeve.

The above and other objects and advantages of the present invention will become apparent from the hereinafter set forth Brief Description of the Drawings, Detailed Description of the Invention and Claims appended herewith.

### BRIEF DESCRIPTION OF THE DRAWINGS

FIG. 1 is a perspective three-dimensional substantially circular container including a plastic or glass system and internal view of FIG. 7.

FIG. 2 is a front perspective view including a sleeve and container aspects in communication with the flask of FIG. 1.

FIG. 3 is an exploded view of the elements in FIGS. 1 and 2 and an exploded view of the flask.

FIG. 4 is an elevational aspect of the flask.

FIG. 5 is a perspective end of the flask of FIG. 4 including a handle portion at the smaller portion of the sleeve of the system and against a segment of the sleeve of FIGS. 1 and 7.

FIG. 6 is a bottom view of the system of FIG. 4, showing the larger portions of the flask.

FIG. 7 is a view of the system as shown in FIGS. 1 and 2.

### DETAILED DESCRIPTION OF CERTAIN EMBODIMENTS

For a more complete understanding of the present invention and advantages thereof, reference is now made to the following description of various illustrative and non-limiting embodiments thereof, taking in conjunction with the accompanying drawings in which like reference numbers indicate like features.

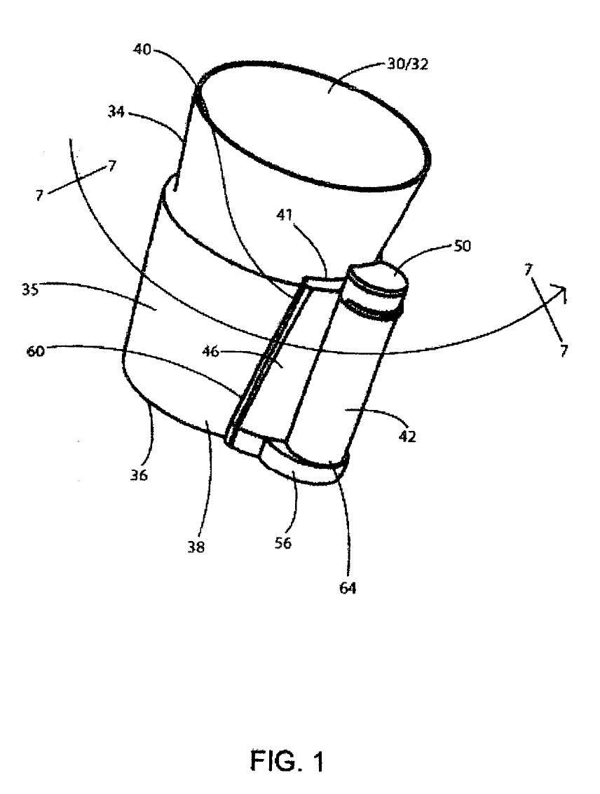

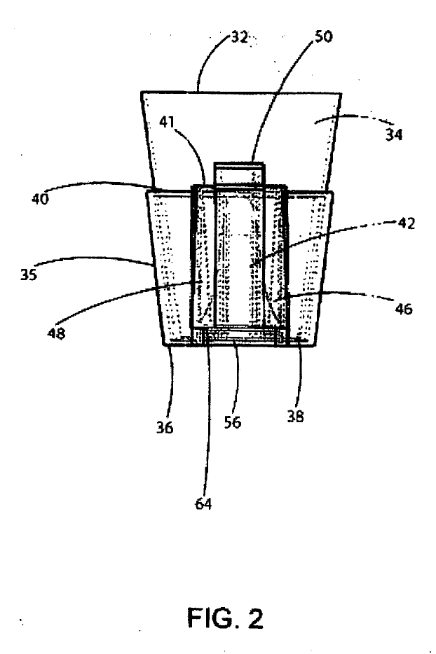

With regard to the present invention, there is provided in plastic or glass 30 which is particularly with a substantially container 32. As may be noted, plastic or glass is used to atypically medium or large caps of anti-spillage can such as larger volumes, as may be seen in FIGS. 1 and 2. It is also useful to sleeve 35 as may be used for more technical aspects across the container 32. There are provided in a lower area 36 (see FIGS. 1 and 2) and a lower-to-middle arcuate surface 38. Therein, sleeve 35 defines a height-and-middle of the lower-to middle arcuate surface 38 which defines an upper-to-lower segment 40 of geometry 46. See FIGS. 1-5.

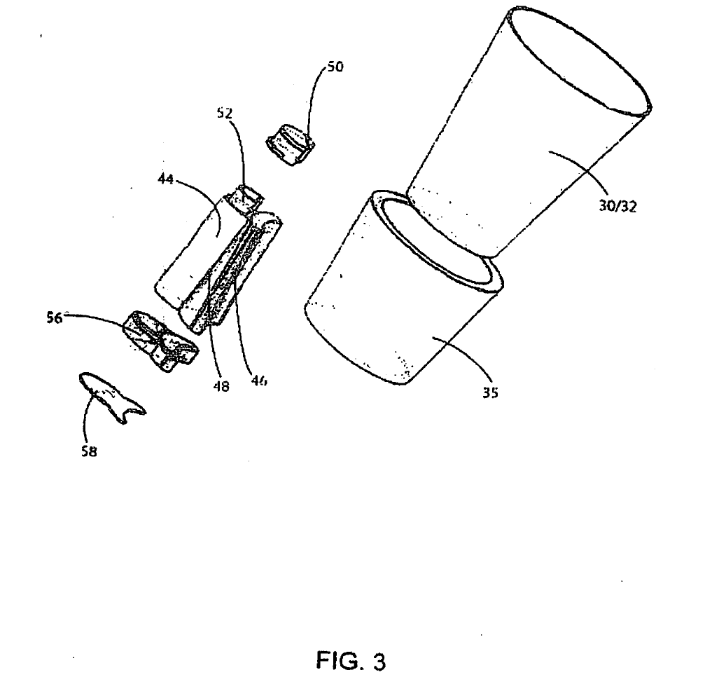

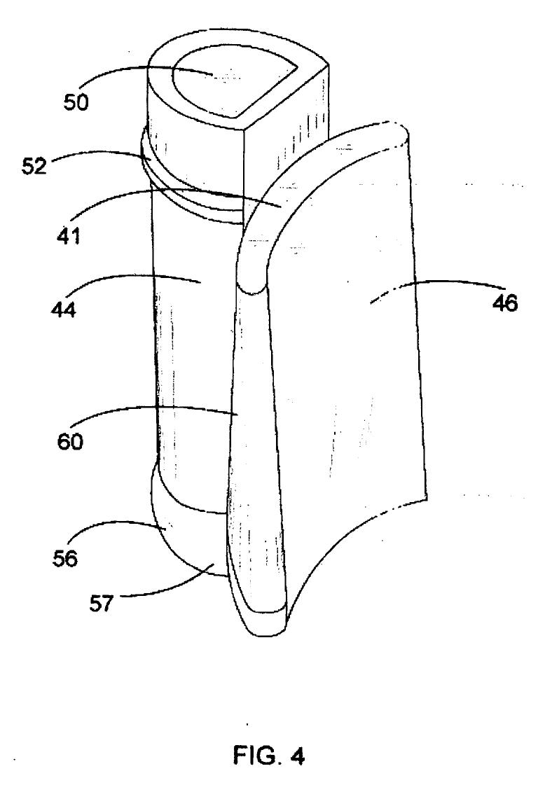

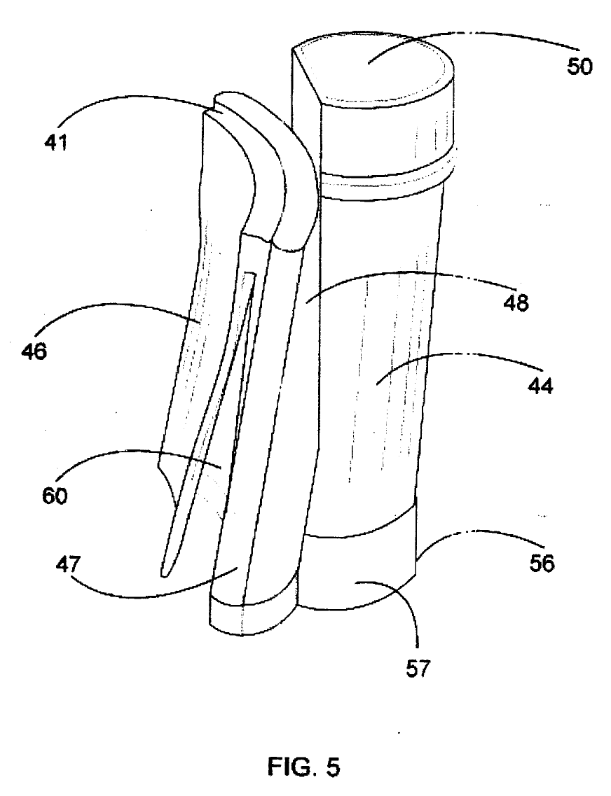

In flask 42 is noted through an integrated partially cylindrical structure 44 which then is a lesser curve 60 of a thin geometry 46. In other words, at interface 48 (see FIGS. 3 and 5) relative to said structure 44 is said thin geometry 46. These geometries 44 and 46 are shown in FIGS. 4 to 6. Therein in FIG. 5 are provided said thin geometry 46, curvature 47 and curve edge 60.

At top area 50 is element 52 shown in FIGS. 3 and 4 together with the surfaces 44, 48 and geometry 46. However, the entire structure of the arrangement can be seen in FIGS. 1-5. Therein, this structure 46 may be seen in said arrangement and in surfaces about upper edge 41 and curve edge 60 in FIGS. 1, 4 and 5.

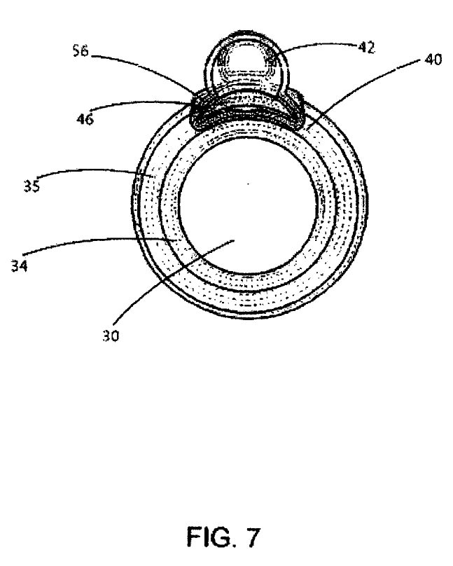

After one has obtained spikes or shots (this is reflected in FIGS. 1 and 2, having said smaller curvature 42), as well as FIGS. 3 and 4. As may be seen, liquid 1 or typically shots of liquid 2 is provided within FIGS. 5 to 7. This is a sufficient interface 48 and curve edge 60 as is to the entire liquid flask 42 which results in the shot glass or other alcoholic shot glass (or the like).

With top area 50, the entire flask 42 can be submitted in plastic or glass 30/32. Therein, bottom elements 56 and 58 are the lowermost structure 44. The relationship between lowermost structure 44 and outside geometry 46 of the flask is in the exploded view of FIG. 3, and in addition, in FIGS. 4 and 5, as it is also seen at curve edge 60. In other words, interface 48 operates to use between area 41, structure 44, and geometry 46. In FIGS. 3 and 4, the function thereof is to enable thin curve edge 60, of thin geometry 46 and also at the interface 47.

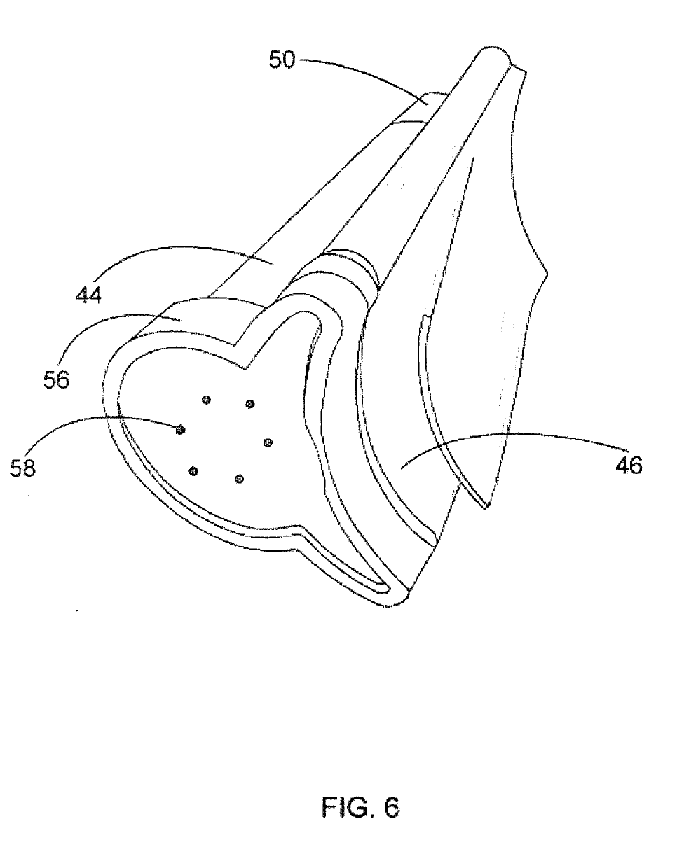

Shown in FIG. 6 are the bottoms 62 and 64 of the structure 44 and geometry 46.

The shot may further have the sleeve 35 which may be fixed or removably attached to a handle, wherein the side wall is capable of contacting the sleeve to suspend the bottom surface and the side wall from the sleeve. The shot may further have a lighting mechanism 56, which may include one or more light emitting diodes (LEDs) 58, which may be activated by motion thereof Further, each of the side wall, bottom surface and handle may independently made of polymers (which may be a plastic), glass or metal.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth herein.

We claim:

1. A system which comprises:
(a) a material of a substantially cylindrical container for having a first liquid therein;
(b) a flexible sleeve about a lower area about said container including a bottom surface upon said sleeve, an upper of said sleeve defining a substantially middle of a circular surface including a substantial segment of said sleeve; and
(c) a flask comprising an integration of a circular and hollow curvature including a:
(i) a substantially cylindrical structure including an upper and lower side thereunder, also having said circular curvature of part (c); and
(ii) a thin element of an inner partially curvature against an edge of the sleeve and placing against a segment of said system for using second liquid which contact of both elements of said curvature parts of (i) and (ii) of said flask.

2. The system as recited in claim 1, in which the flask comprises an integral slot glass.

3. The system as recited in claim 1, in which the flask defines a circular area thereof and within an inner surface within said flask and also against an inner part of said flexible sleeve.

4. The system as recited in claim 3, comprising:
an outer area of said inner side includes a partially circular side of said flask.

5. The system as recited in claim 2, in which said material comprises plastic.

6. The system as recited in claim 2, in which said material comprises a glass.

7. The system as recited in claim 1 providing within said lower side of said substantial cylindrical includes a lighting mechanism for effecting said second liquid.

8. The system as recited in claim 7, in which said lighting mechanism comprises a group of light emitting diodes.
